(19) United States
(12) Patent Application Publication
(10) Pub. No.: US 2006/0030630 A1
(43) Pub. Date: Feb. 9, 2006

(54) System, method and composition for forming composite sprayed polyurethane skins having an expanded polyurethane layer

(75) Inventors: Nelson E. Williams JR., Saline, MI (US); Joseph T. Donatti, Howell, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/912,345

(22) Filed: Aug. 5, 2004

(51) Int. Cl. B05D 1/36

(52) U.S. Cl. 521/50; 427/402; 264/50; 264/240; 264/309

(57) ABSTRACT

The present invention relates to a method and system for making a composite polyurethane skin, said method comprises providing a source of liquid polyol, providing a source of liquid isocyanate, providing a source of liquid blowing agent, providing a spray mold tool having a mold surface, providing a spraying device for spraying liquid material at the spray mold tool, directing polyol and isocyanate to the spraying device to form a polyurethane composition, spraying the polyurethane composition towards the spray mold tool to form a polyurethane skin layer on the spray mold tool, directing polyol, isocyanate and blowing agent to the spraying device to form an expandable polyurethane composition, and spraying the expandable polyurethane composition onto the skin layer to form a resilient expandable polyurethane layer on the skin.

### BACKGROUND OF THE INVENTION

1. Field of the Invention

The invention relates to composite skins and panels having an expanded polyurethane layer, compositions for making the expanded polyurethane layer, and method and system for making the same.

2. Background Art

Panels comprising a relatively hard substrate covered at least in part by a flexible cover skin are relatively well known. It is also relatively well known to provide a foam layer between the substrate and the skin if a softer panel is desired. A relatively common technique for providing the foam between the substrate and the skin is to foam in place a foam layer therebetween. To do so, the cover skin and the substrate are manufactured separately and placed in a foaming mold in a spaced apart relation so that foam forming material can be introduced between the cover skin and the substrate perform a foam layer therebetween.

One commonly used material for forming the cover skin is polyurethane. One suitable technique for forming the polyurethane cover skins is to spray a polyurethane composition, minimally comprising polyol and isocyanate, at a spray mold. Using conventional foam in place technology, after the polyurethane cover skin has been formed, it is then removed from the spray forming mold and placed in a foam in place mold along with the substrate in a spaced apart relationship.

It would be desirable to simplify the manufacturing process of substrates having polyurethane skins and desiring a soft touch.

### SUMMARY OF THE INVENTION

In at least one embodiment of the invention, a method for making a composite polyurethane skin is provided the method comprises providing a source of liquid polyol, providing a source of liquid isocyanate, providing a source of liquid blowing agent, providing a spray mold tool having a mold surface, providing a spraying device for spraying liquid material at the spray mold tool, directing polyol and isocyanate to the spraying device to form a polyurethane composition, spraying the polyurethane composition towards the spray mold tool to form a polyurethane skin layer on the spray mold tool, directing polyol, isocyanate and blowing agent to the spraying device to form an expandable polyurethane composition, and spraying the expandable polyurethane composition onto the skin layer to form a resilient expanded polyurethane layer on the skin.

In at least one embodiment, the expandable polyurethane composition comprises polyol present in an amount of 50 to 90 weight percent, isocyanate present in an amount of 15 to 45 weight percent and blowing agent present in an amount of 0.1 to 6 weight percent.

In at least one embodiment, a system for making a composite polyurethane skin is provided. The system comprises a source of liquid polyol, a source of liquid isocyanate, a source of liquid blowing agent, a spray mold tool having a mold surface, and a spraying device for spraying liquid material at the spray mold tool. The spraying device is capable of receiving polyol from the polyol source and isocyanate from the isocyanate source to form a polyurethane composition for spraying towards the spray mold tool to form a polyurethane skin layer on the spray mold tool. The spraying device is further capable of receiving isocyanate from the isocyanate source, blowing agent from the blowing agent source and polyol to form an expandable polyurethane composition for spraying onto the skin layer to form a resilient expanded polyurethane layer on the skin.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 illustrates a cross-sectional view of a panel made in accordance with at least one aspect of the present invention;

FIG. 2 is a schematic view of a spray tool and spray assembly for use in forming a part of the panel illustrated in FIG. 1; and

FIG. 3 is a view similar to FIG. 2 showing the forming of another part.

### DETAILED DESCRIPTION OF THE PREFERRED EMBODIMENTS

As required, detailed embodiments of the present invention are disclosed herein. However, it is to be understood that disclosed embodiments are merely exemplary of the invention that may be embodied in various alternative forms. The figures are not necessarily to scale, some features may be exaggerated or minimized to show details of particular components. Therefore, specific structural and functional details disclosed herein are not to be interpreted as limiting, but merely as a representative basis for the claims and/or a representative basis for teaching one skilled in the art to variously employ the present invention. Moreover, except where otherwise expressly indicated, all numerical quantities in this description and in the claims indicating amounts of materials or conditions of reactions and/or use are to be understood as modified by the word “about” in describing the broadest scope of this invention. Practice within the numeral limit stated is generally preferred. Also, unless expressly stated to the contrary, percent, “parts of”, and ratio values are by weight and the description of a group or class of materials as suitable or preferred for a given purpose in connection with the invention implies that mixtures of any two or more members of the group or class may be equally suitable or preferred.

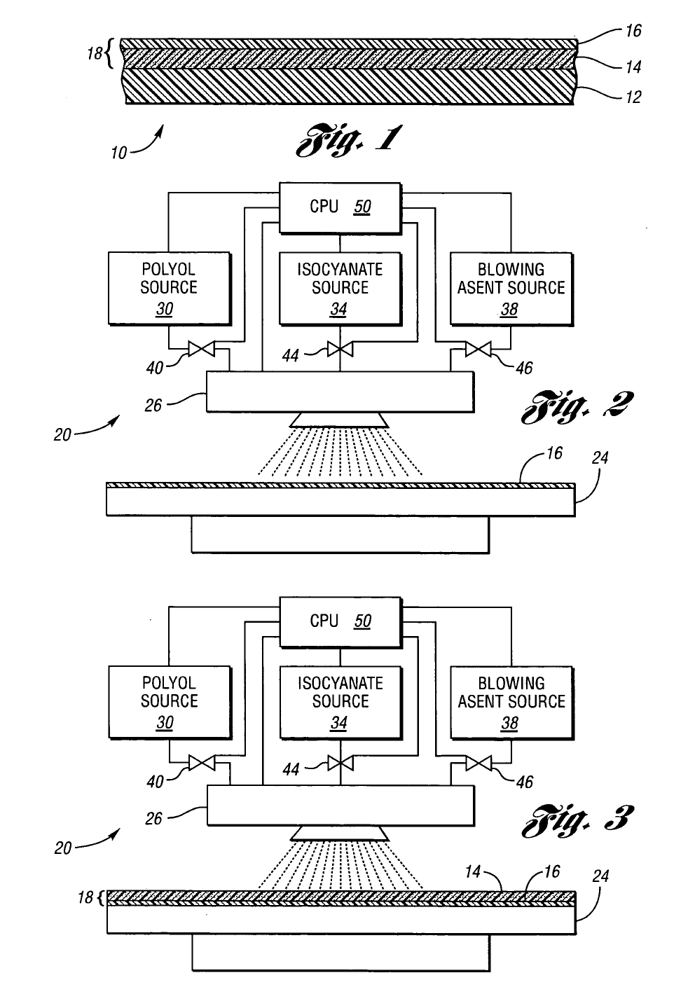

Referring to FIG. 1, there is illustrated a panel 10 made in accordance with at least one embodiment of the present invention. In at least one embodiment, the panel 10 comprises a relatively hard substrate 12, an expanded polyurethane resilient layer 14 disposed on substrate 12, and a polyurethane cover skin 16 disposed on layer 14. The resilient layer 14 and the cover skin 16 comprise a composite polyurethane skin 18. The panel 10 may be suitable for use as a vehicle interior trim panel, such as a door panel, instrument panel, door cover, console cover, shelf, trim cover, pillar trim panel, or the like, or it may be used in other applications where such a panel is desired. In certain embodiments, the substrate 12 may be omitted and/or other materials and/or layers may be disposed between layer 14 and substrate 12.

The substrate 12 is a rigid structural member that provides support for the remainder of the panel, and may comprise any suitable material. For example, the substrate 12 may be made of plastic or reinforced plastic, such as fiberglass reinforced polyurethane. Additional examples of suitable plastics, besides polyurethane, include polypropylene, polyethylene, acrylonitrile butadiene styrene (ABS), polycarbonate (PC), ABS/PC blends, GRU and RRIM. In at least one embodiment, the substrate 12 may have a general thickness of 0.5 to 5.0 mm, in another embodiment, 1.0 to 3.5 mm, and in yet another embodiment 2.0 to 3.0 mm.

The skin layer 16 is adhered to the resilient layer 14. The skin layer 16 is configured to provide a covering over the resilient layer 14 and may comprise any sufficiently dense polyurethane material. For example, the skin layer 16 may be a solid aliphatic or aromatic polyurethane layer. The skin layer may have a suitable thickness and density. For example, the skin layer 16 may have a thickness in the range of 0.4 to 2.0 mm, and a density in the range of 0.85 to 1.2 g/cm³. In at least one embodiment of the invention, the skin layer 16 has a thickness in the range of 0.5 to 1.2 mm, and a density in the range of 0.95 to 1.1 g/cm³.

An optional coating (not shown) may be used to protect the skin layer 16 and/or to provide a decorative surface for the panel 10. For example, the coating may be used to inhibit sunlight and/or other ultraviolet light from reaching the skin layer 16. As another example, the coating may be used as a paint to provide a desired color and/or texture to the panel 10. While the coating may comprise any suitable material, in at least one embodiment, one such suitable material comprises an aliphatic polyurethane composition. If a coating is provided, the coating may have any suitable thickness such as a thickness of approximately 0.5 to 1 mil.

The resilient layer 14 may comprise any suitable sprayed expanded polyurethane material. The resilient layer 14 may help to provide a soft feel to the panel 10. In at least one embodiment, suitable materials can provide a resilient layer 14 that has a density in the range of 0.1 to 0.75 g/cm³, in another embodiment between 0.15 to 0.5 g/cm³, and in yet another embodiment between 0.2 to 0.3 g/cm³. In at least one embodiment, the resilient layer may have a shore A hardness of 30 to 50.

In at least one embodiment, the resilient layer 14 primarily may comprise a low permeable, relatively closed cell material. In at least one embodiment, the resilient layer 14 may comprise 35 to 75 percent closed cell structures, in at least another embodiment 40 to 65 percent closed cell structures, and in yet at least another embodiment 45 to 55 percent closed cell structures, based upon the entire resilient layer 14.

In at least one embodiment, the resilient layer 14 may have varying closed cell density throughout the resilient layer. In at least one embodiment, the top portion (the portion closer to the skin layer 16) and the lower portion (the portion closer to the substrate 12) may independently comprise at least 85 percent closed cell structures, in other embodiments between 90 to 100 percent closed cell structures, and in yet other embodiments between 95 and 100 percent closed cell structures. In at least one embodiment, the top and bottom portions may independently comprise between 2.5 to 25 percent, in other embodiments between 5 to 20 percent, and in yet other embodiments between 10 to 15 percent, of the thickness of the resilient layer 14. The remaining intermediate layer (the portion between the top and bottom portion) of the resilient layer 14 may comprise between 40 to 95 percent closed cell structures, in at least another embodiment between 50 to 90 percent closed cell structures, and in yet another embodiment between 60 to 85 percent closed cell structures. In at least one embodiment, the average cell structure size can vary between 0.05 mm to 3.0 mm, and in yet other embodiment between 0.5 mm to 1.0 mm.

The resilient layer 14 may be any suitable thickness. In at least one embodiment, the resilient layer 14 may have a thickness between 0.1 and 30 mm. In at least another embodiment, the resilient layer 14 has a thickness of 1.0 to 15 mm.

The resilient layer 14 may be formed from an expandable polyurethane composition. In at least one embodiment, the expandable polyurethane composition comprises polyol, isocyanate, and a blowing agent. The blowing agent may comprise any suitable blowing agent that will result in a resilient layer having a density in the range of 0.1 to 0.75 g/cm³ and/or a surface with a shore A hardness of 30 to 50. In at least one embodiment, the blowing agent may comprise water and/or a catalyst. In at least one embodiment, the blowing agent can be present in an amount of 0.1 to 6 weight percent of the expandable polyurethane composition.

In at least one embodiment, the expandable polyurethane composition usable with the present invention comprises:

| COMPONENT | WEIGHT % |
|---|---|
| Polyol | 50 to 90% |
| Isocyanate | 15 to 45% |
| Blowing Agent | 0.1 to 6% |

In at least another embodiment, the expandable polyurethane composition usable with the present invention comprises:

| COMPONENT | WEIGHT % |
|---|---|
| Polyol | 65 to 75% |
| Isocyanate | 20 to 35% |
| Blowing Agent | 0.6 to 3.0% |

In at least yet another embodiment, the expandable polyurethane composition usable with the present invention comprises:

| COMPONENT | WEIGHT % |
|---|---|
| Polyol | 70.5% |
| Isocyanate | 28% |
| Blowing Agent | 1.5% |

In at least one embodiment, the expandable polyurethane composition usable with the present invention comprises:

| COMPONENT | WEIGHT % |
|---|---|
| Polyol | 50 to 90% |
| Isocyanate | 15 to 45% |
| Catalyst | 0.1 to 5% |
| Water | 0.05 to 5.0% |

In at least another embodiment, the expandable polyurethane composition usable with the present invention comprises:

| COMPONENT | WEIGHT % |
|---|---|
| Polyol | 65 to 75% |
| Isocyanate | 20 to 35% |
| Catalyst | 0.5 to 2.5% |
| Water | 0.1 to 1.0% |

In at least yet another embodiment, the expandable polyurethane composition usable with the present invention comprises:

| COMPONENT | WEIGHT % |
|---|---|
| Polyol | 70.5% |
| Isocyanate | 28% |
| Catalyst | 1.2% |
| Water | 0.3% |

In at least one embodiment, the polyol is any suitable polyol or blend of polyols that will react with the other composition components such as isocyanate, catalyst and water, to form an expanded polyurethane having a density of 0.1 to 0.75 g/cm³.

In at least one embodiment, the polyol may have an OH number of 100 to 150, and in other embodiments 124 to 135 and in yet other embodiments 131. In at least one embodiment, the polyol may have an equivalent weight of 125 to 150, and in other embodiments of 130 to 140. In at least one embodiment, the polyol may have a specific gravity of 0.990 to 0.999, and in other embodiment of 0.995 to 0.998.

In at least one embodiment, one suitable polyol comprises 58148R available from BASF of Wyandotte, Mich.

The isocyanate in at least one embodiment is any suitable isocyanate that when reacted with the other composition components will result in an expanded polyurethane foam having a density of 0.1 to 0.75 g/cm³. In at least one embodiment, the isocyanate will have an NCO content of about 10 to 40 weight percent, in other embodiments between 15 and 30 weight percent and in yet other embodiments of 21 to 24 percent. In at least one embodiment, the isocyanate may be a prepolymer blend of isocyanate with a stoichrometric-lean amount of polyol (such as 20 to 40%). In at least one embodiment, a particularly suitable isocyanate comprises the prepolymer blend of isocyanate with polyol such as 51840T available from BASF.

Other conventional components may be present in the expandable polyurethane composition of the present invention. These other conventional components include, but are not necessarily limited to, surfactant, cell openers, other catalysts, water, emulsifiers, and lower molecular weight polyols such as quadrol, which is a chain extender polyol, etc.

In at least one embodiment, the catalyst may be a delayed-action catalyst. In at least one embodiment, the catalyst may be a water soluble amine catalyst. In at least one embodiment, the suitable amine catalysts may have viscosities of 45 to 80 CPS at 25° C., in other embodiments 55 to 70 CPS, and in yet other embodiments of 61 CPS. In certain embodiments, the amine catalyst may have an OH number of between 350 and 600 mg/KOH/g and in yet other embodiments between 400 and 525 and in yet other embodiments 475. The amine catalyst may be acid-blocked to enable it to have a delayed action on the other polyurethane composition components.

Referring to FIG. 2, a system 20 for manufacturing the composite skin 18 is provided. The system 20 comprises a spraying mold tool 24 having a spray receiving surface, generally corresponding to the surface of the panel 10, for receiving the polyurethane compositions and particularly the polyurethane composition for forming the skin 16. The system 20 further includes a spraying apparatus 26. Any suitable spraying apparatus, such as a robotic high pressure (such as 400 to 2,000 psi) spray apparatus having one or more movable spray nozzles, may be used. The tool 24 may be heated to any suitable temperature if desired, such as in the range of 150° C. to 165° C.

A liquid polyol source 30 is provided. As stated above, any suitable polyol or polyol blend can be used. One suitable polyol comprises 51840R available from BASF. In at least one embodiment, the polyol employed may be a polyether polyol. Examples of suitable liquid polyols, usable as the polyol source 30, include, but are not necessarily limited to, graft polyols, PhD polyols, polymer polyols, and PIPA polyols. The liquid polyol could have suitable additives, especially if aliphatic, such as UV and antioxidant inhibitors/stabilizers.

A liquid isocyanate source 34 is provided. Any suitable liquid isocyanate, such as aromatic isocyanate, can be used. Examples of suitable aromatic liquid isocyanates include, but are not necessarily limited to, MDI and PDI. Alternatively, the liquid aliphatic isocyanate could also be used. The liquid isocyanate could have suitable additives such as UV inhibitors/stabilizers, especially if the liquid isocyanate is aliphatic.

A liquid blowing agent source 38 is provided. In at least one embodiment, the blowing agent comprises any suitable blowing agent that will enable the blowing agent, polyol, and isocyanate to react to form a resilient expanded polyurethane layer 14 having a density of 0.1 to 0.75 g/cm³ and/or a shore A hardness of 30 to 50. In one embodiment, the blowing agent comprises a delayed-action catalyst, water, or both. In one embodiment, the blowing agent comprises a delayed-action catalyst and water. In one embodiment, a specific example of a delayed-action catalyst is the acid-blocked amine catalyst DABCO® BL-17 available from Air Products & Chemicals, Inc. of Allentown, Pa. In another embodiment, the amine catalyst DABCO® BL-22 can be employed.

In at least one embodiment, the blowing agent can be premixed with, and comprise one or more of the composition components, such as polyol. In this embodiment, the blowing agent composition in the blowing agent source can comprise 50 to 90 weight percent polyol, 10 to 30 weight percent catalyst and 1 to 20 percent water. In at least another embodiment, the blowing agent composition in the blowing agent source can comprise 60 to 80 weight percent polyol, 15 to 25 weight percent catalyst and 5 to 15 weight percent water. In at least another embodiment, the blowing agent composition in the blowing agent source can comprise 76 weight percent polyol, 19 weight percent catalyst and 5 weight percent water.

In at least one embodiment, the components in the polyol source 30, the isocyanate source 34, and the blowing agent source are maintained at elevated temperatures, such as 70 to 125° F. and may be provided at a pressure between 400 to 2,000 psi to the spray device 26.

In at least one embodiment, the polyurethane skin 16 is made by first mixing a stream of polyol from the polyol source 30 with a stream of isocyanate from the isocyanate source 34 to form a stream of polyurethane forming material (i.e., polyurethane composition) to be directed from the spray device 26 towards the spraying mold 24, as shown in FIG. 2. The polyurethane composition forms the skin 16 on the mold 24. Valves 40 and 44 respectively are provided to enable control of the amount and speed of the polyol and isocyanate provided to the spraying device 26.

After the skin 16 has been formed, valve 46 may be opened to allow a stream of blowing agent to be delivered to the spraying device 26. Valves 40 and 44 may also be manipulated at this time to alter (and/or stop) the flow of polyol and/or isocyanate being delivered to spraying device 26 from their respective sources 30 and 34. It should be understood that a different spraying device than the spraying device 26 used for forming skin 16 could be used to form the resilient layer 14. It should be further understood that if a different spraying device than spraying device 26 is to be used, the spraying device could be the same type (i.e., a high pressure) spraying device as spraying device 26. CPU 50 can be provided to control the operation of the delivery of the components to, and the spraying of, the spraying device 26. In at least one embodiment, the polyol, isocyanate, and blowing agent mix in the spraying device 26 to form an expandable polyurethane forming composition that is directed towards the skin 16, as is shown in FIG. 3. The expandable material may be allowed to free rise to achieve a desired density. The expandable polyurethane forming composition forms resilient layer 14 on skin 16.

In at least one embodiment, when the composition in the blowing agent comprises 50 to 90 weight percent polyol, 10 to 30 weight percent catalyst, and 1 to 20 weight percent water, the components are being delivered to the spraying device 26 to form the expandable polyurethane forming composition in the following amounts:

| STREAM | WEIGHT PER SECOND | |
|---|---|---|
| Polyol | 8 to 14 | grams per second |
| Isocyanate | 3.5 to 6.0 | grams per second |
| Blowing Agent | 0.1 to 2 | grams per second |

In at least another embodiment, when the composition in the blowing agent comprises 50 to 90 weight percent polyol, 10 to 30 weight percent catalyst, and 1 to 20 weight percent water, the components are being delivered to the spraying device 26 to form the expandable polyurethane forming composition in the following amounts:

| STREAM | WEIGHT PER SECOND | |
|---|---|---|
| Polyol | 9.5 to 11 | grams per second |
| Isocyanate | 4.2 to 4.6 | grams per second |
| Blowing Agent | 0.5 to 1.5 | grams per second |

In at least yet another embodiment, when the composition in the blowing agent comprises 50 to 90 weight percent polyol, 10 to 30 weight percent catalyst, and 1 to 20 weight percent water, the components are being delivered to the spraying device 26 to form the expandable polyurethane forming composition in the following amounts:

| STREAM | WEIGHT PER SECOND | |
|---|---|---|
| Polyol | 10.5 | grams per second |
| Isocyanate | 4.5 | grams per second |
| Blowing Agent | 1.0 | grams per second |

In at least one embodiment, the components are being delivered to the spraying device 26 to form the expandable polyurethane forming composition in the following amounts:

| STREAM | WEIGHT PER SECOND | |
|---|---|---|
| Polyol | 9.5 to 15 | grams per second |
| Isocyanate | 3.0 to 6.0 | grams per second |
| Catalyst | 0.05 to 0.4 | grams per second |
| Water | 0.01 to 2.0 | grams per second |

In at least another embodiment, the components are being delivered to the spraying device 26 to form the expandable polyurethane forming composition in the following amounts:

| STREAM | WEIGHT PER SECOND | |
|---|---|---|
| Polyol | 10.5 to 12 | grams per second |
| Isocyanate | 4 to 5 | grams per second |
| Catalyst | 0.1 to 0.3 | grams per second |
| Water | 0.1 to 1.0 | grams per second |

In at least yet another embodiment, the components are being delivered to the spraying device 26 to form the expandable polyurethane forming composition in the following amounts:

| STREAM | WEIGHT PER SECOND | |
|---|---|---|
| Polyol | 11.26 | grams per second |
| Isocyanate | 4.5 | grams per second |
| Catalyst | 0.19 | grams per second |
| Water | 0.05 | grams per second |

After the skin 16 and resilient layer 14 (i.e., composite skin 18) has been made, it can be secured to a substrate 12, if desired, by any suitable method, such as adhesively securing to a preformed substrate. Furthermore, a foam or other layer could be provided between the composite skin 18 and the substrate 12, as desired.

While embodiments to the invention have been illustrated and described, it is not intended that these embodiments illustrate and describe all the possible forms of the invention. Furthermore, the omission or schematic illustration of conventional equipment, such as pumps, valves, heaters, etc., should not be interpreted as certain conventional equipment not being needed or present in the system or as limiting the invention in any manner. Rather, the words used in the specification are words of description rather than a limitation, and it is understood that various changes may be made without departing from the spirit and scope of the invention.

What is claimed is:

1. A method for making a composite polyurethane skin, said method comprises:
providing a source of liquid polyol;
providing a source of liquid isocyanate;
providing a source of liquid blowing agent;
providing a spray mold tool having a mold surface;
providing a spraying device for spraying liquid material at the spray mold tool;
directing polyol and isocyanate to the spraying device to form a polyurethane composition;
spraying the polyurethane composition towards the spray mold tool to form a polyurethane skin layer on the spray mold tool;
directing polyol, isocyanate and blowing agent to the spraying device to form an expandable polyurethane composition; and
spraying the expandable polyurethane composition onto the skin layer to form a resilient expanded polyurethane layer on the skin.

2. The method of claim 1 wherein the resilient layer has a density of 0.1 to 0.75 g/cm³.

3. The method of claim 1 wherein the expandable polyurethane composition comprises polyol present in an amount of 50 to 90 weight percent, isocyanate present in an amount of 15 to 45 weight percent and blowing agent in an amount of 0.1 to 6 weight percent.

4. The method of claim 3 wherein the blowing agent comprises an agent selected from the group consisting of a delayed-action catalyst and water.

5. The method of claim 4 wherein the blowing agent comprises both catalyst and water.

6. The method of claim 3 wherein the polyol in the expandable composition is provided to the spraying device in a first stream, the isocyanate in the expandable composition is provided to the spraying device in a second stream and the blowing agent in the expandable composition is provided to the spraying device in a third stream.

7. The method of claim 3 wherein a first portion of the polyol in the expandable polyurethane composition is provided to the spraying device in a first stream, a second portion of the polyol in the expandable polyurethane composition is provided to the spraying device in a second stream, separate from the first stream, and the blowing agent is provided to the spraying device in the second stream.

8. The method of claim 7 wherein the streams are delivered to the spraying device in the following manner:

| STREAM | WEIGHT PER SECOND | |
|---|---|---|
| Polyol | 8 to 14 | grams per second |
| Isocyanate | 3.5 to 6.0 | grams per second |
| Blowing Agent | 0.1 to 2 | grams per second |

9. The method of claim 2 wherein the polyurethane skin has a thickness of 0.4 to 2 mm.

10. The method of claim 9 wherein the resilient layer has a thickness of 0.1 to 15 mm and a shore A hardness of 30 to 50.

11. The method of claim 5 wherein the expandable polyurethane composition comprises:

| COMPONENT | WEIGHT % |
|---|---|
| Polyol | 50 to 90% |
| Isocyanate | 15 to 45% |
| Delayed-Action Amine Catalyst | 0.1 to 5% |
| Water | 0.05 to 5.0% |

12. A sprayable expandable polyurethane composition for forming a sprayed skin, said composition comprising:
polyol;
isocyanate; and
blowing agent, wherein the components are present in an amount such that a resulting layer of polyurethane, when cured, will have a density in the range of 0.1 to 0.75 g/cm³.

13. The composition of claim 12 wherein the expandable polyurethane composition comprises polyol in an amount of 50 to 90 weight percent, isocyanate present in an amount of 15 to 45 weight percent and blowing agent present in an amount of 0.1 to 6 weight percent.

14. The composition of claim 13 wherein the blowing agent comprises at least one component selected from the group consisting of catalyst and water.

15. The composition of claim 14 wherein the blowing agent comprises a delayed-action amine catalyst and water.

16. The composition of claim 15 wherein the composition comprises:

| COMPONENT | WEIGHT % |
|---|---|
| Polyol | 50 to 90% |
| Isocyanate | 15 to 45% |
| Catalyst | 0.1 to 5% |
| Water | 0.05 to 5.0% |

17. A system for making a composite polyurethane skin, system comprising:
a source of liquid polyol;
a source of liquid isocyanate;
a source of liquid blowing agent;
a spray mold tool having a mold surface; and
a spraying device for spraying liquid material at the spray mold tool;
the spraying device being able to receive polyol from the polyol source and isocyanate from the isocyanate source to form a polyurethane composition for spraying towards the spray mold tool to form a polyurethane skin layer on the spray mold tool;
the spraying device being able to receive isocyanate from the isocyanate source, blowing agent from the blowing agent source, and polyol to form an expandable polyurethane composition for spraying onto the skin layer to form a resilient expanded polyurethane layer on the skin.

18. The system of claim 17 wherein the polyol in the expandable composition is provided to the spraying device in a first stream, the isocyanate in the expandable composition is provided to the spraying device in a second stream and the blowing agent in the expandable composition is provided to the spraying device in a third stream.

19. The system of claim 17 wherein a first portion of the polyol in the expandable polyurethane composition is provided to the spraying device in a first stream, a second portion of the polyol in the expandable polyurethane composition is provided to the spraying device in a second stream, separate from the first stream, and the blowing agent is provided to the spraying device in the second stream.

20. The system of claim 19 wherein the streams are delivered to the spraying device in the following manner:

| STREAM | WEIGHT PER SECOND | |
|---|---|---|
| Polyol | 8 to 14 | grams per second |
| Isocyanate | 3.5 to 6.0 | grams per second |
| Blowing Agent | 0.1 to 2 | grams per second |
